(19) United States
(12) Patent Application Publication
(10) Pub. No.: US 2007/0235497 A1
(43) Pub. Date: Oct. 11, 2007

(54) Rotating type soldering device

(75) Inventor: Hul-Chun Hsu, Taichung City (TW)

Correspondence Address: HDSL, 4331 STEVENS BATTLE LANE, FAIRFAX, VA, 22033, US

(73) Assignee: JAFFE LIMITED

(21) Appl. No.: 11/399,319

(22) Filed: Apr. 7, 2006

(51) Int. Cl. B23K 3/00

(52) U.S. Cl. 228/51

(57) ABSTRACT

A rotating type soldering device is used for soldering a heat pipe and includes a rotation mechanism. The rotation mechanism includes an actuator and a plurality of wheels. The heat pipe is arranged between the wheels. A soldering mechanism with a solder gun is arranged on one side of the rotation mechanism. The solder gun is corresponding to one side of the heat pipe and electrically connected to a first electrode. A liquid-supplying mechanism is arranged atop the wheels. The liquid-supplying mechanism is electrically connected to a second electrode, which has different polarity with the first electrode. Therefore, the liquid-supplying mechanism can supply electrically conductive liquid to an exterior portion of the heat pipe. The electrical arc is intense and the thermal deform of heat pipe is small.

### BACKGROUND OF THE INVENTION

1. Field of the Invention

The present invention relates to a rotating type soldering device, especially to a rotating type soldering device for sealing opening end of heat pipe when the rotating type soldering device is in rotational contact with the heat pipe.

2. Description of Prior Art

The heat pipes are extensively used for heat dissipation in electronic devices because the heat pipes have advantages of high and fast thermal transmission ability, high thermal transmission rate, light weight, simple structure and versatile usage. Moreover, the heat can be dissipated without consuming electrical power. However, the working fluid is vaporized after the heat pipe is heated and pressure in the heat pipe is rapidly increased. The vaporized working fluid tends to leak from sealed opening. Therefore, it is important issue to enhance sealing effect for opening of the heat pipe.

The prior art soldering device for heat pipe generally includes a stage and a rounded rotating disk on the stage, where a plurality of clams are provided for the rounded rotating disk and a plurality of processing stations are also provided around the rounded rotating disk. Each of the processing station is provided with a soldering device with a solder gun. The rounded rotating disk is rotated to move the heat pipe to the soldering device and the opening of the heat pipe is soldered.

The above-mentioned soldering device can seal end of the heat pipe. However, the surface of heat pipe has risk of scratch to influence yield because the soldering device has bulky size and the heat pipe is fixed by clams. Moreover, the heat pipe is soldered without rotation thereof. The molten solder paste tends to flow in undesired direction due to gravity. The opening at end of heat pipe cannot be completely sealed or sealed with thick solder. The yield is reduced. Moreover, electrodes are connected to the solder gun and the rotating disk, respectively. The resulting electrical arc is not condensed and the problem is worsen due to excessive thermal deformation of heat pipe.

### SUMMARY OF THE INVENTION

The present invention is to provide a rotating type soldering device, where the liquid-supplying mechanism and the soldering mechanism thereof are connected to electrodes with different polarities. Therefore, intense electrical arc can be generated and the thermal deform of the heat pipe is small because the heat pipe and the wheels are in rotational contact.

Accordingly, the present invention provides a rotating type soldering device, which is used for soldering a heat pipe and includes a rotation mechanism, a soldering mechanism and a liquid-supplying mechanism. The rotation mechanism includes an actuator and a plurality of wheels. The heat pipe is arranged between the wheels. The soldering mechanism with a solder gun is arranged on one side of the rotation mechanism. The solder gun is corresponding to one side of the heat pipe and electrically connected to a first electrode. The liquid-supplying mechanism is arranged atop the wheels. The liquid-supplying mechanism is electrically connected to a second electrode, which has different polarity with the first electrode. Therefore, the liquid-supplying mechanism can supply electrically conductive liquid to an exterior portion of the heat pipe.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a sectional view of the first preferred embodiment of the present invention.

FIG. 2 shows a top view of the first preferred embodiment of the present invention.

FIG. 3 shows a sectional view of the second preferred embodiment of the present invention.

### DETAILED DESCRIPTION OF THE INVENTION

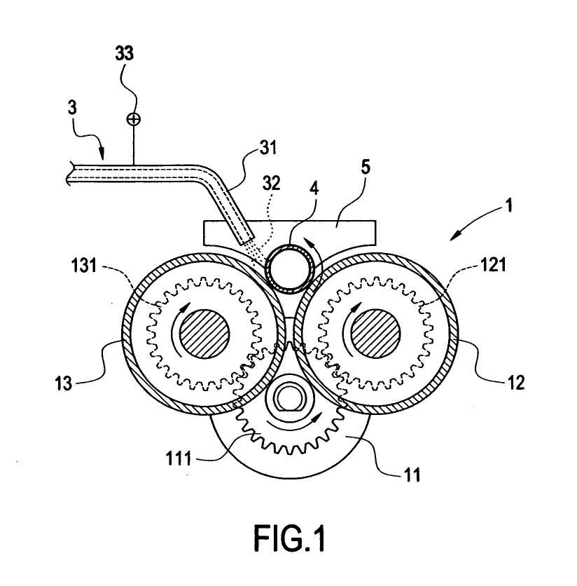

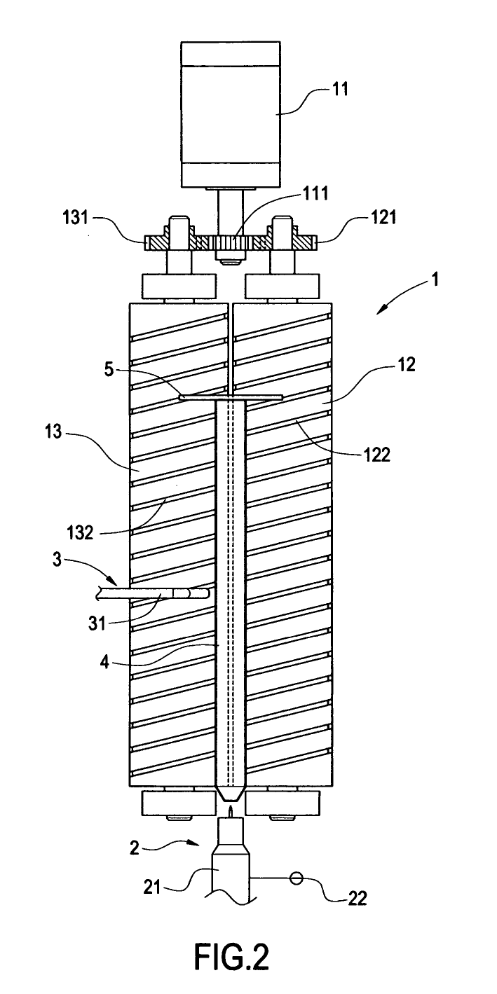

With reference to FIGS. 1 and 2, the present invention provides a rotating type soldering device. The rotating type soldering device according to the present invention can be used to seal an opening end of a heat pipe 4 or a press-closing end of the heat pipe 4. The rotating type soldering device mainly includes a rotation mechanism 1, a soldering mechanism 2 and a liquid-supplying mechanism 3.

The rotation mechanism 1 includes an actuator 11, a pair of wheels 12, 13 driven by the actuator 11 and a supporting rack (not shown) for fixing the wheels 12, 13. In the preferred embodiment, the actuator 11 is a motor. The shaft of the wheels 12, 13 are fit with gears 111, 121, 131 such that the gear 111 is engaged with the gears 121 and 131. It should be noted the transmission between the actuator 11 and the wheels 12, 13 can be achieved by chain or belt.

The axis lines of the wheels 12 and 13 are parallel to each other. The front end and the rear end of the wheels are parallel to each other. The wheels 12 and 13 are rotated in the same direction, where the heat pipe 4 is placed between the wheels 12 and 13, and is in rotational contact with the heat pipe 4. The wheels 12 and 13 include slanting grooves 122 and 132 on surface thereof such that a lateral pushing force is generated to move the heat pipe along the same direction, when the wheels 12 and 13 are in rotational contact with the heat pipe 4.

The soldering mechanism 2 is arranged on one side of the rotation mechanism 1 and includes a solder gun 21, where the solder gun 21 is separated with the heat pipe 4 and the wheels 12 and 13. The solder gun 21 is at opening end of the heat pipe 4 and electrically connected to a first electrode 22. The first electrode 22 can be an anode or a cathode. In the preferred embodiment, the first electrode 22 is a cathode.

The liquid-supplying mechanism 3 is arranged atop the wheels 12 and 13 and includes a tube 31 and a liquid flowing out of the tube 31. The tube 31 is electrically to a second electrode 33 with different polarity to the first electrode 22, thus pouring electrically conductive fluid to an exterior portion of the heat pipe 4.

The rotating type soldering device further includes a baffle 5 arranged atop the wheels 12 and 13, and corresponding to an opposite end of the heat pipe 4, which is opposite to the solder gun 21. A non-soldering end of the heat pipe 4 is in contact with the baffle 5.

During manufacture, the heat pipe 4 is arranged between the wheels 12 and 13, and the actuator 11 operates to rotate the wheels 12 and 13 in the same direction, thus rotating the heat pipe 4. The wheels 12 and 13 include slanting grooves 122 and 132 to abut the non-soldering end of the heat pipe 4 to the baffle 5. Afterward, the solder gun 21 of the soldering mechanism 2 seals the opening end of the heat pipe 4 by soldering. The tube 31 and the solder gun 21 are connected to electrodes of different polarities, whereby intense electrical arc can be produced when the heat pipe 4 is rotated with the wheels 12 and 13. The sealed end of the heat pipe 4 can be more uniformed and reliable because the heat pipe has little deformation.

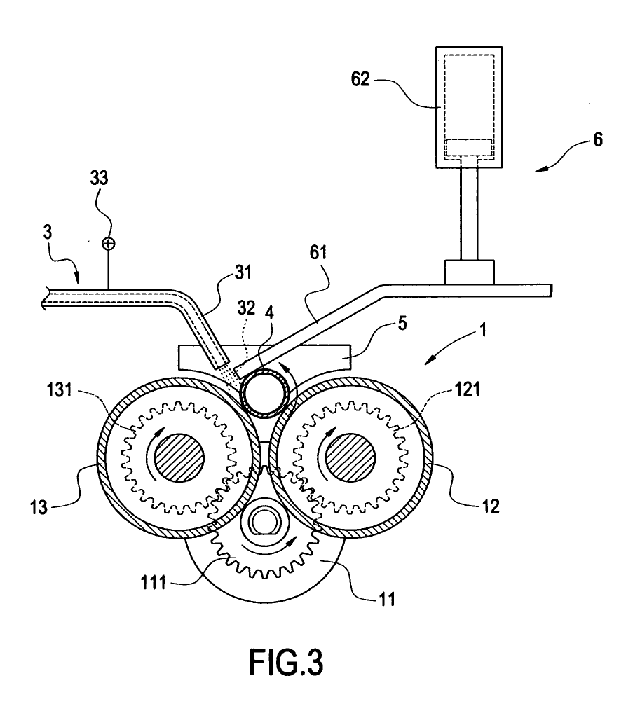

FIG. 3 shows a sectional view of the second preferred embodiment of the present invention. The soldering mechanism 2 further includes a pressing mechanism 6 atop the heat pipe 4. The pressing mechanism 6 includes a pressing plate 61, or a pressing plate 61 and a telescopic unit 62 connected to one end of the pressing plate 61. In the shown preferred embodiment, the mechanism 6 includes a pressing plate 61 and a telescopic unit 62. The telescopic unit 62 controls an up-down movement of the pressing plate 61, whereby the heat pipe 4 is elastically clamped between the wheels 12, 13 and the pressing plate 61. The heat pipe 4 will not jitter during rotation and the soldering quality of the heat pipe 4 can be ensured.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A rotating type soldering device for soldering a heat pipe, comprising:
a rotation mechanism comprising an actuator and a pair of wheels driven by the actuator, wherein the wheels are rotated in the same direction, the heat pipe is placed between the wheels and is in rotational contact with the wheels;
a soldering mechanism arranged on one side of the rotation mechanism and comprising a solder gun corresponding to a first end of the heat pipe, the solder gun electrically connected to a first electrode; and
a liquid-supplying mechanism arranged atop the wheels and electrically connected to a second electrode, which has a different polarity with that of the first electrode, the liquid-supplying mechanism supplying an electrically conductive liquid to an exterior portion of the heat pipe.

2. The rotating type soldering device as in claim 1, wherein the first electrode is one of anode and cathode.

3. The rotating type soldering device as in claim 1, wherein the actuator is a motor.

4. The rotating type soldering device as in claim 3, wherein the motor and the wheels are engaged through gear.

5. The rotating type soldering device as in claim 3, wherein the motor and the wheels are engaged through chain or belt.

6. The rotating type soldering device as in claim 1, wherein the wheels comprises slanting grooves on surface thereof.

7. The rotating type soldering device as in claim 1, wherein the front end and the rear end of the wheels are parallel to each other.

8. The rotating type soldering device as in claim 1, wherein the liquid-supplying mechanism comprises a tube and a liquid flowing outward from the tube, the tube electrically connected to the second electrode.

9. The rotating type soldering device as in claim 1, further comprising a baffle corresponding to a second end of the heat pipe, which is opposite to the first end, the heat pipe being abutted to the baffle.

10. The rotating type soldering device as in claim 9, further comprising a pressing mechanism atop the heat pipe, the pressing mechanism comprising a pressing plate to clamp the heat pipe resiliently between the wheels and the pressing plate.

11. The rotating type soldering device as in claim 10, wherein the pressing mechanism further comprises a telescopic unit connected to one end of the pressing plate, which is opposite to the heat pipe, in order to control up-down movement of the pressing plate.

12. The rotating type soldering device as in claim 1, further comprising a pressing mechanism atop the heat pipe, the pressing mechanism comprising a pressing plate to clamp the heat pipe resiliently between the wheels and the pressing plate.
